(19) United States
(12) Patent Application Publication
(10) Pub. No.: US 2002/0048508 A1
(43) Pub. Date: Apr. 25, 2002

(54) Anti-inertia stack

(76) Inventor: Lawrence A. Ward, Collegeville, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/843,457

(22) Filed: Apr. 26, 2001

Related U.S. Application Data
(60) Provisional application No. 60/200,677, filed on Apr. 28, 2000.

(51) Int. Cl. B65H 29/00; B65G 57/09

(52) U.S. Cl. 414/794.7

(57) ABSTRACT

An anti-inertia stacker for products which are prone to dislodgment on or from a substrate during processing movement is provided. The anti-inertia stacker comprises a traveling pallet which is mounted for movement. The traveling pallet receives a product-laden substrate from a conveyor or other placement device while traveling at substantially the same speed as the conveyor. The traveling pallet includes a conveying surface which moves in a direction opposite to a direction of travel of the traveling pallet. The conveying surface, moving in the direction opposite to the direction of travel of the product-laden substrate, decelerates the received product-laden substrate. The product-laden substrate can then be stacked without dislodging the product from the substrate.

### CROSS-REFERENCE TO RELATED APPLICATIONS

This application claims the benefit of U.S. Provisional Patent Application No. 60/200,677, filed Apr. 28, 2000.

### BACKGROUND

Automated food processing machines have become prevalent in the art for creating food “set-ups” for future use, such as sandwich making, and for creating stacks of food products for storage and shipping. Certain foods however, such as cooked bacon, are difficult to stack because they are slippery. Many foods contain an amount of grease necessitating the use of a substrate which is resistant to grease permeation, such as waxed or plasticized paper. When the food on the substrate is decelerated from a conveyor in order to stack it for shipping or additional processing, the foods have a tendency to slide along the substrate surface, causing spillage and uneven stacking.

In one prior known automatic in-line food preparation machine, disclosed in U.S. Pat. No. 5,768,857, of which the present inventor is a co-inventor, slices or pieces of food product are placed on a conveyor system and transferred onto an approved substrate, such as paper or polyethylene, introduced onto the conveyor beneath the food product as the food product travels along the conveyor path. Thereafter, the food product-laden substrate is transferred to a stacker to produce a neat and efficient stack of the food products separated by the substrates. However, for slippery foods, the deceleration required at the stacker causes the food products to move on or even slide off the substrate, requiring the equipment to run at reduced speeds, well below the capacity of the equipment.

In one known application, cooked bacon was layered or stacked on a 9-inch by 14-inch paper substrate. The deceleration for transferring each bacon-laden substrate from the conveyor to the stacker necessitates a reduced conveyor speed so that only approximately 20-22 units per minute of cooked bacon laden substrates can be stacked without causing the bacon to slide off the substrate upon entry to the stacker.

The inherent limitations for the above described systems inhibit the overall efficiency of stacking operations. Currently, there is a need for an efficient and cost-effective stacking mechanism for slippery products, such as cooked bacon, which are placed on substrates and stacked.

### SUMMARY

The present invention provides an anti-inertia stacker for products which are prone to dislodgment on or from a substrate during processing movement. The anti-inertia stacker comprises a traveling pallet which is mounted for movement. The traveling pallet receives a product-laden substrate from a conveyor or other placement device. The traveling pallet includes a conveying surface which moves in a direction opposite to a direction of travel of the traveling pallet. A drive actuator is in contact with the traveling pallet at least in a stacking area to drive the conveying surface.

In another aspect, the invention provides an anti-inertia stacker having a traveling pallet as described above with two drive actuators. The drive actuators are moveable from a first, active position which contacts the traveling pallet to a second, non-active position. Two stacking pallets are provided to accept items to be stacked from the conveying surface to a top of a respective stack.

### BRIEF DESCRIPTION OF THE DRAWING(S)

FIG. 1 is a top perspective view of the anti-inertia stacker in conformance with the present application.

FIG. 2 is a side view of a drive actuator and rollers for a traveling pallet.

FIG. 3 is a side view of a drive actuator with gear teeth and intermeshing pinion gears located on rollers of a traveling pallet.

FIG. 4 is a side view of a continuous belt drive actuator with rollers of a traveling pallet.

FIG. 5 is a side view of two drive actuators, a traveling pallet and two stacking pallets.

### DETAILED DESCRIPTION OF THE PREFERRED EMBODIMENT(S)

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the anti-inertia stacker 10 in accordance with the present invention and designated parts thereof. The terminology includes the words noted above as well as derivatives thereof and words of similar import.

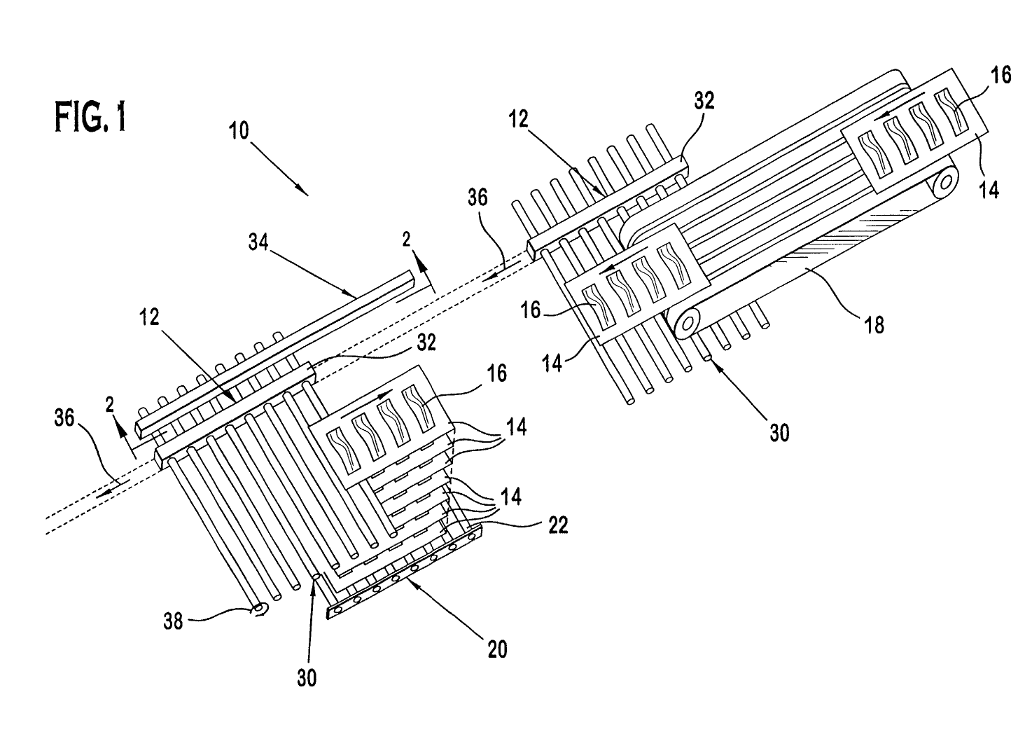

Referring to FIG. 1, an anti-inertia stacker 10 in accordance with the present invention is shown. The anti-inertia stacker 10 could be used with automatic in-line food preparation equipment, such as that disclosed in U.S. Pat. No. 5,768,857, which is incorporated herein by reference as if fully set forth. However, it is not necessary to fold over the product carrying substrate or paper.

The anti-inertia stacker 10 includes a traveling pallet, platform or support 12 (referred to generally herein as “the traveling pallet 12”) which receives a substrate 14 loaded with a product 16, such as cooked bacon, from a conveyor 18. In a preferred embodiment, the conveyor runs at 150 feet per minute and delivers 40 food product laden substrates 14 per minute to the traveling pallet 12.

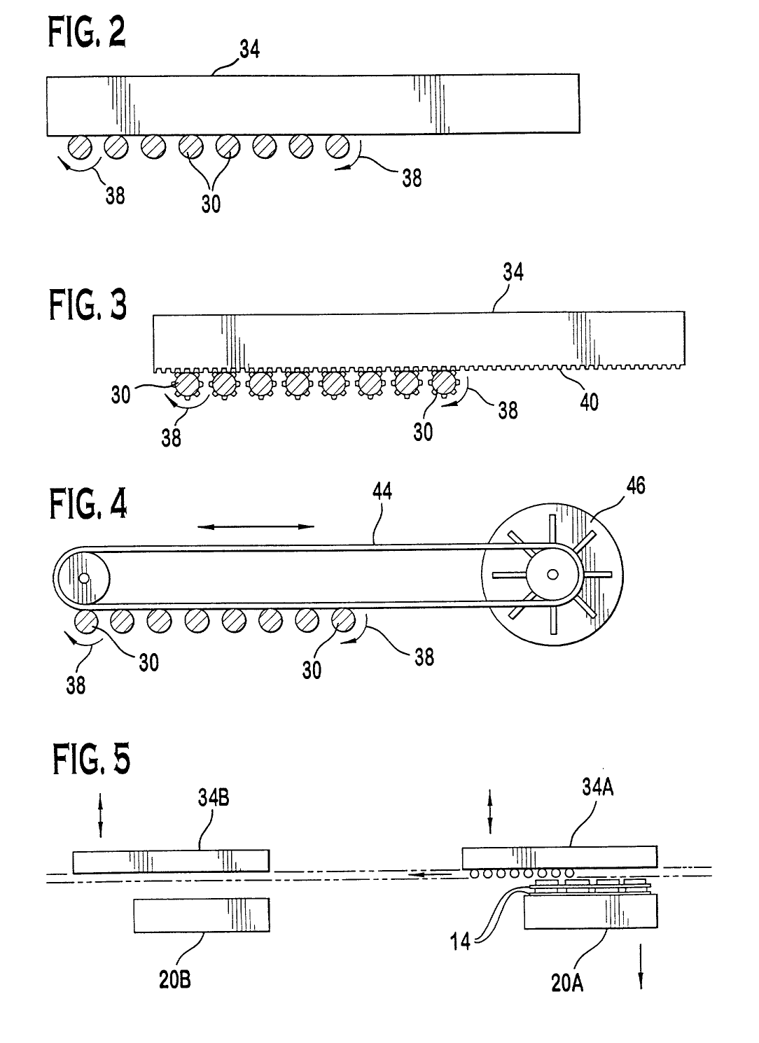

As shown in FIGS. 1 and 2, the traveling pallet 12 is mounted for movement in the same direction as the conveyor 18, and may be mounted in a vertical or horizontal carousel arrangement, such that a plurality of traveling pallets 12 can be moved from a product receiving position at the end of the conveyor 18 to an unloading position over a stacking pallet, platform or other suitable support 20 (referred to generally herein as “the stacking pallet 20”). Preferably, the stacking pallet 20 comprises a lowering mechanism which lowers the product as it stacks, such that the first product laden substrate 14 drops only a short distance from the traveling pallet 12 to the stacking pallet 20, prior to the stacking pallet 20 moving downwardly, such that the next product laden substrate 14 can be stacked on top of the previous product laden substrate 14. The lowering mechanism preferably allows accumulation of a pre-set number of product-laden substrates onto a stack and discharges the accumulated stack onto a conveyor or table. The lowering mechanism is preferably of the type known in the art, which is mounted for controllable vertical movement downwardly to create a stack of product-laden substrates 14 for packaging. The stacking pallet 20 may include rollers 22 that form the pallet surface. The rollers may be connected to a drive motor for rotating rollers forward to unload the stacking pallet 20 when a pre-set quantity of the product laden substrates 14 are stacked thereon. The surface of the pallet 20 could also be formed by a continuous belt or a fixed surface, if desired.

In the first preferred embodiment, the traveling pallet 12, comprises a plurality of rollers 30 which are mounted for rotary movement in a support 32, preferably in bearings. However, other rotatable mounting arrangements may be utilized, if desired. Positioned along the path of the traveling pallet 12 is a roller actuating bar 34 located in proximity to the stacking pallet 20. As each traveling pallet 12 approaches the roller actuating bar 34, the rollers 30 sequentially contact the roller actuating bar 34 which acts as a drive actuator, causing the rollers to rotate in a direction opposite to the direction of travel of the pallet 12. For example, as shown in FIG. 1, the traveling pallet 12 moves from right to left, as indicated by arrows 36, while the rollers 30 are rotated in the clockwise direction as indicated by arrow 38. This sequential contact of the rollers 30 with the actuating bar 34 as the traveling pallet 12 continues to move forward gradually decelerates the food product laden substrate 14, due to the sequential contact of the rollers 30 sliding against the bottom of the substrate 14 until enough rollers 30 contact the actuating bar 34 so that the substrate does not slide relative to the rollers 30. The substrate is thereby decelerated to a zero velocity with respect to the stacking pallet 20 and is rolled from the traveling pallet 12 onto the stacking pallet 20. This provides for stacking of slippery products, including food products such as cooked bacon, at more than twice the rate previously attainable utilizing the prior known stacking equipment. Alternatively, a motor can be located on the traveling pallet 12 to act as the drive actuator.

Referring now to FIG. 3, a second preferred embodiment of the invention with an alternate arrangement of the actuating bar 34 and rollers 30 is shown. In contrast to the arrangement shown in FIG. 2, each roller 30 includes a pinion gear 38, and the actuating bar includes gear teeth 40 which engage the pinion gears 38 on the rollers 30 to rotate the rollers 30.

Referring now to FIG. 4, a third preferred embodiment of the invention is shown in which the actuating bar 34 is replaced by a motorized band or belt 44 which contacts the rollers 30. This allows the speed of rotation of the rollers 30 to be controlled separately from the velocity of the traveling pallets 12 to provide for a slower deceleration of the product laden substrate 14. Preferably, the belt or band 44 is driven by a motor 46, and both the speed and direction of rotation of the belt 44 can be controlled, as desired.

While it is preferred that the traveling pallets 12 be located on a carousel arrangement, it is also possible to use a single traveling pallet 12 which reciprocates between the loading position at the end of the conveyor 18 and the stacking position, as shown in FIG. 1. It is also possible to utilize the traveling pallet 12 in connection with two or more stacking pallets 20A, 20B as shown in FIG. 5, with each stacker having an associated actuating bar 34A, 34B. The actuating bars 34A, 34B are controllably moveable between first and second positions into and out of the path of the rollers 30, such that when a full stack of product is located on stacking pallet 20A, the actuating bar 34A is raised and actuating bar 34B is lowered, such that the product laden substrates 14 are stacked on the second stacking pallet 20B. The mechanisms used to raise and lower the actuating bars 34A, 34B are of the type generally known in the art, and may be pneumatic actuators or any other suitable arrangement.

It is also possible to provide a traveling pallet 12 having a continuous belt as the supporting surface for the product laden substrate 14. In this case, movement of the continuous belt can be controlled by a motor located on the traveling pallet 12 which acts as the drive alternator. Alternatively, the actuating bar 34 could be used in connection with a rack-and-pinion drive or other suitable drive means for rotating the belt in a direction opposite to the direction of travel of the pallet 12.

The present invention may be embodied in other specific forms without departing from the spirit or central attributes thereof and, accordingly, the present invention is not limited to the specific embodiments disclosed, but is intended to refer to any stacker providing for active deceleration of a product laden substrate prior to the substrate being stacked.

What is claimed is:

1. An anti-inertia stacker comprising:
a traveling pallet mounted for movement including a support and a conveying surface adapted to receive a moving item to be stacked, the conveying surface being driven in a direction opposite to a direction of movement of the traveling pallet and
a drive actuator in contact with the traveling pallet at least in a stacking area to drive the conveying surface.

2. The anti-inertia stacker of claim 1, wherein the traveling pallet is mounted for movement from a receiving position, where the moving item to be stacked is placed on the conveying surface, to a stacking position, where the item to be stacked is adapted to be deposited on a stacking pallet.

3. The anti-inertia stacker of claim 1, wherein the conveying surface is a plurality of parallel rollers rotatably connected to the support such that the rollers rotate upon contact with the drive actuator.

4. The anti-inertia stacker of claim 3, further comprising:
a set of pinion gears connected to the plurality of parallel rollers; and
a set of gear teeth on the drive actuator, the gear teeth meshing with the set of pinion gears when the traveling pallet contacts the drive actuator.

5. The anti-inertia stacker of claim 1, wherein the traveling pallet is mounted on a carousel.

6. The anti-inertia stacker of claim 1, wherein the drive actuator is a bar.

7. The anti-inertia stacker of claim 1, wherein the drive actuator is a belt.

8. The anti-inertia stacker of claim 7, wherein the belt is continuous.

9. The anti-inertia stacker of claim 8, further comprising a motor, drivingly connected to the belt.

10. The anti-inertia stacker of claim 9, wherein the motor has an adjustable speed control.

11. The anti-inertia stacker of claim 1, further comprising a stacking pallet adapted to receive an item to be stacked from the conveying surface; and
a lowering mechanism connected to the stacking pallet.

12. The anti-inertia stacker of claim 1, wherein the conveying surface is a continuous belt.

13. The anti-inertia stacker of claim 12, further comprising a motor, drivingly connected to the continuous belt.

14. The anti-inertia stacker of claim 12, wherein the motor has an adjustable speed control.

15. The anti-inertia stacker of claim 1, further comprising first and second rollers supporting the conveying surface of the traveler pallet, the first roller having a pinion gear thereon; and
a set of gear teeth connected to the drive actuator, the gear teeth meshing with the pinion gear of the first roller upon contact between the traveling pallet and the drive actuator.

16. An anti-inertia stacker comprising:
a traveling pallet mounted for movement including a support and a conveying surface adapted to receive a moving item to be stacked, the conveying surface being driven in a direction opposite to a direction of the traveling pallet,
first and second drive actuators being movable from a first, active position, in contact with the traveling pallet in at least one of a first and second stacking area to drive the conveying surface, to a second, non-active position,
a first stacking pallet located in the first stacking area adapted to accept an item to be stacked from the conveying surface in a first stack; and
a second stacking pallet located in the second stacking area adapted to accept an item to be stacked from the conveying surface in a second stack.

17. The anti-inertia stacker of claim 16, wherein the conveying surface is a plurality of parallel rollers rotatably connected to the support such that the rollers rotate upon contact with the drive actuator.

18. The anti-inertia stacker of claim 16, wherein the conveying surface is a belt.
